(19) United States
(12) Patent Application Publication
(10) Pub. No.: US 2017/0303277 A1
(43) Pub. Date: Oct. 19, 2017

(54) METHOD AND DEVICE FOR REALIZING D2D PROCESSING

(71) Applicant: ZTE CORPORATION, Shenzhen City (CN)

(72) Inventors: Wenhuan WANG, Shenzhen City (CN); Shuanshuan WU, Shenzhen City (CN); Youxiong LU, Shenzhen City (CN); Yu Ngok LI, Shenzhen City (CN); Shuanghong HUANG, Shenzhen City (CN)

(73) Assignee: ZTE CORPORATION, Shenzhen City (CN)

(21) Appl. No.: 15/513,750

(22) PCT Filed: Jul. 20, 2015
(86) PCT No.: PCT/CN2015/084506

§ 371 Date: Mar. 23, 2017

(30) Foreign Application Priority Data
Sep. 25, 2014 (CN) 201410499998.4

(51) Int. Cl. H04W 72/04; H04W 76/02; H04L 12/24

(52) U.S. Cl. CPC H04W 72/0446; H04L 41/0893; H04W 76/023

(57) ABSTRACT

A method and device for realizing device-to-device (D2D) processing are described. The method includes: according to a preset policy for determining a positional relationship between an initial transmission resource unit and a retransmission resource unit, determining resource allocation information of SA information for a D2D communication; and according to the determined resource allocation information of the SA information, acquiring a resource and conducting D2D communication processing.

### CROSS-REFERENCE TO RELATED APPLICATIONS

This application is the U.S. national phase of PCT Application No. PCT/CN2015/084506 filed Jul. 20, 2015, which claims priority to Chinese Application No. 201410499998.4 filed Sep. 25, 2014, the disclosures of which are incorporated in their entirety by reference herein.

### TECHNICAL FIELD

The present disclosure relates to a near field communication technology, and more particularly to a Device-to-Device (D2D) processing implementation method and apparatus.

### BACKGROUND

Near field data sharing between users, small-range social contact and commercial activities, as well as specific services oriented to local specific users gradually become a growth point which cannot be ignored in a next-stage radio platform. Generally, service data of a service type having obvious local characteristics does not need to come from a core network and only needs to be completed between User Equipments (UEs). This communication pattern is also called as a D2D communication mode having characteristics obviously distinguished from a traditional cellular system communication pattern. As for near field communication users capable of employing the D2D communication mode, D2D transmission not only saves radio spectral resources, but also reduces the data transmission pressure of the core network, thereby reducing occupation of system resources, increasing the spectral efficiency of a cellular communication system, reducing the emission power consumption of a terminal, and saving the network operation cost to a great extent.

Resource allocation of a D2D UE is divided into two working patterns from a sending layer according to whether D2D is covered by a traditional network. Herein, the first working pattern is that when D2D is covered by the traditional network, an evolved Node B (eNB) or a rel-10 relay node schedules a resource, for the D2D UE to send; and the other working pattern is that when D2D is not covered by the traditional network, the D2D UE self-selects a resource from a resource pool, for the D2D UE to send.

Regardless of the mode, during D2D communication, due to direct communication between UEs, a sending end of the D2D UE needs to send Scheduling Assignment (SA) information for indicating physical channel resource information and control information of sent D2D data. As for the first working pattern, the eNB configures the sending end of the D2D UE with SA and data resources. As for the second working pattern, the sending end of the D2D UE selects SA and data resources from the resource pool. Regardless of the scenario, SA resources should be scheduled first, and SA schedules and indicates data resources.

SA serves as a carrier for data indication, and is equivalent to data control information. The requirement for reliability thereof is very high. At present, implementation of an SA pattern is not mature. For example, system duplexity restricts mutual monitoring between D2D UEs as for the problem of collision in the second working pattern. Therefore, in order to improve the reliability of SA design, a current standard conference has proposed to support a retransmission mechanism so as to further improve the reliability of SA.

A D2D resource pool is a group of time frequency resources for D2D UEs, and may be pre-configured or configured by a network. The D2D resource pool contains an SA resource pool and a data resource pool, and is configured by Time Division Multiplex (TDM). According to the current standard conference, transmission of SA for one time is supported. The size of each SA resource unit is a Physical Resource Block (PRB) pair in a frequency domain. That is, the SA resource unit is a sub-frame in a time domain, and the frequency occupies 12 sub-carriers. As for the first working pattern, a scheduling eNB schedules and sends SA and data resource configuration of a D2D UE, and the eNB notifies a sending end of the D2D UE to send SA and data, and a receiving end of the D2D UE obtains data resource indication and control information by reading SA, and then reads data information. As for the second working pattern, the sending end of the D2D UE randomly selects or selects SA resources and data resources in a certain manner, and indicates data resource and control information by means of SA, and the receiving end of the D2D UE obtains data resource indication and control information by reading SA, and then reads data information. However, during implementation of these two working patterns, since duplexity restricts mutual monitoring between UEs, the D2D UEs may not monitor SA.

### SUMMARY

The present disclosure provides a D2D processing implementation method and apparatus, capable of avoiding the problem of restriction of duplexity on mutual monitoring between UEs, and capable of ensuring that a D2D UE may monitor SA of the D2D UE, simultaneously sent, at other moments.

A D2D processing implementation method includes the following steps.

Resource configuration information of SA information for a D2D communication is determined in accordance with a preset policy for determining a positional relationship between an initial transmission resource unit and a retransmission resource unit.

A resource is acquired according to the determined resource configuration information of the SA information, and D2D communication processing is carried out.

The resource of the SA information for the D2D communication includes:

X SA resource units composed of (Nf frequency domain SA resource units×Nt SA time domain resource units), the size of each SA resource unit being a PRB pair;

the X SA resource units are used for configuring T logical channels, a physical resource position of each logical channel being determined according to a sending count and the preset policy for determining the positional relationship between the initial transmission resource unit and the retransmission resource unit;

herein, Nt represents a maximum number of time domain SA resources within an SA period, and Nf represents a maximum number of frequency domain SA resources.

The resource is a resource pool or a resource group within an SA period.

The frequency domain SA resource units in the resource pool or the resource group are continuously assigned or discontinuously assigned.

The time domain SA resource units in the resource pool or the resource group are continuously assigned or discontinuously assigned.

The policy for determining the positional relationship between the initial transmission resource unit and the retransmission resource unit is that:

the physical resource positions for initial transmission and retransmission of the SA information are fixed, and located at different time domain sub-frame and frequency domain positions.

When the number of the frequency domain SA resource units of the resource pool or the resource group is Nf and Nf is an even number, the policy that the physical resource positions for initial transmission and retransmission of the SA information are fixed and located at different time domain sub-frame and frequency domain positions includes that:

the physical resource position for one transmission is located at an upper frequency band of the resource pool or the resource group, and the physical resource position for the other transmission is located at a lower frequency band or is configured in accordance with a preset frequency offset, thereby ensuring position staggered.

A relationship between the physical resource positions for two transmissions is:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t, Nt);

in a frequency domain, second_nf=first_nf+ceil(Nf/2);

where, second_nt is a physical resource position on the time domain for the second transmission, first_nt is a physical resource position on the time domain for the first transmission, second_nf is a physical resource position on the frequency domain for the second transmission, first_nt is a physical resource position on the frequency domain for the first transmission, shift_t is a shift parameter of a time domain unit, mod represents a modulo operation, and ceil(Nf/2) is a frequency domain offset.

When the number of the frequency domain SA resource units of the resource pool or the resource group is Nf and Nf is an odd number, the policy that the physical resource positions for initial transmission and retransmission of the SA information are fixed and located at different time domain sub-frame and frequency domain positions includes that:

unpaired odd rows are located in the middle of a first frequency domain resource or a last frequency domain resource or section in frequency domain resources, a frequency domain SA resource unit remained after even rows are paired is taken, and the physical resource positions for two transmissions satisfy the following relationship:

on a time domain resource: the physical resource position second_nt on the time domain for the second transmission is the sum of the physical resource position first_nt on the time domain for the first transmission and the frequency domain offset ceil(Nf/2);

on a frequency domain resource: the physical resource position second_ft on the frequency for the second transmission is identical to the physical resource position first_ft on the frequency domain for the first transmission.

When Nf is an odd number, after an odd row position is determined, the relationship between the physical resource positions for two transmissions is that:

a frequency domain SA resource unit remained after even rows are paired is located in the middle of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2);

or, a frequency domain SA resource unit remained after even rows are paired is located at a tail or tail row of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2);

where, shift_t is a shift parameter of a time domain unit, and shift_f is a shift parameter of a frequency domain unit; mod represents a modulo operation; and when a resource group mode is adopted, shift_t is less than Nt/2.

When the number of frequency domain SA resource units of the resource pool or the resource group within an SA period is Nf and the number of time domain SA resource units is Nt, the policy that the physical resource positions for initial transmission and retransmission of the SA information are fixed and located at different time domain sub-frame and frequency domain positions includes that:

the physical resource position for one transmission is located in the resource pool or the resource group (first_nt, first_nf), the opposite physical resource position for the other transmission is located in the resource pool or the resource group (second_nt, second_nf), and the physical resource positions for two transmissions satisfy the following relationship:

in a time domain,

as for a clockwise cycle mode,

second_nt=mod[Nt+first_nt+floor(first_nf/(2×shift_f))×shift_f+mod(first_nf,shift_f)−shift_t,Nt];

as for an anticlockwise cycle mode,

second_nt=mod[first_nt+floor(first_nf/(2*shift_f))×shift_f+mod(first_nf,shift_f)+shift_t, Nt]; and

in a frequency domain, second_nt=first_nt+shift_f−floor[(first_nf+shift_f)/Nf]×[1+mod(first_nf,shift_f)];

where, shift_t is a shift parameter of a time domain unit, and shift_f is a shift parameter of a frequency domain unit; and mod represents a modulo operation, and floor is rounding down.

When Nf is an odd number, a row of frequency resources is remained after pairing, the physical resource position for one transmission is located at a front part of Nt, and the physical resource position for the other transmission is located at a rear part of Nt. The physical resource positions for two transmissions satisfy the following relationship:

in a time domain, second_nt=first_nt+ceil(Nt/2); and

in a frequency domain, second_nf=first_nf.

The resource configuration information of the SA information for the D2D communication includes:

a logical channel indication for indicating a physical resource position of each logical channel in the resource pool;

or, the resource configuration information includes a logical channel indication for indicating a physical resource position of each logical channel in the resource group and a resource group indication.

The logical channel indications are sorted in accordance with a configured physical resource frequency, or time or intervals.

The step that a resource is acquired according to the determined resource configuration information of the SA information and D2D communication processing is carried out includes that:

a resource is selected according to a resource group indication in the resource pool included in the determined resource configuration information of the SA information for the D2D communication and a logical channel indication of a logical channel corresponding to the resource group; or a resource is selected according to a logical channel indication of a logical channel corresponding to the resource pool included in the determined resource configuration information of the SA information for the D2D communication; or, a resource is selected according to position information in the time domain for initial transmission and retransmission and position information in the frequency domain for initial transmission; and

D2D communication processing is carried out according to the selected resource.

The resource configuration information of the SA information for the D2D communication is determined by an eNB and then sent to a D2D UE.

Or, the D2D UE monitors and acquires the resource for the D2D communication.

A D2D processing implementation apparatus includes a determination unit and a processing unit, herein

the determination unit presets a preset policy for determining a positional relationship between an initial transmission resource unit and a retransmission resource unit, and is arranged to determine resource configuration information of SA information for a D2D communication according to the policy; and

the processing unit is arranged to acquire a resource according to the determined resource configuration information of the SA information, and carry out D2D communication processing.

The resource of the SA information for the D2D communication includes:

X SA resource units composed of (Nf frequency domain SA resource units×Nt SA time domain resource units), the size of each SA resource unit being a PRB pair;

the X SA resource units are used for configuring T logical channels, a physical resource position of each logical channel being determined according to a sending count and the preset policy for determining the positional relationship between the initial transmission resource unit and the retransmission resource unit;

herein, Nt represents a maximum number of time domain SA resources within an SA period, and Nf represents a maximum number of frequency domain SA resources.

The resource is a resource pool or a resource group within an SA period.

The frequency domain SA resource units in the resource pool or the resource group are continuously assigned or discontinuously assigned.

The time domain SA resource units in the resource pool or the resource group are continuously assigned or discontinuously assigned.

The policy for determining the positional relationship between the initial transmission resource unit and the retransmission resource unit is that:

the physical resource positions for initial transmission and retransmission of the SA information are fixed, and located at different time domain sub-frame and frequency domain positions.

When the number of the frequency domain SA resource units of the resource pool or the resource group is Nf and Nf is an even number, the physical resource positions for initial transmission and retransmission of the SA information are fixed and located at different time domain sub-frame and frequency domain positions, and the determination unit is arranged to:

locate the physical resource position for one transmission at an upper frequency band of the resource pool or the resource group, locate the physical resource position for the other transmission at a lower frequency band or configure in accordance with a preset frequency offset, thereby ensuring position staggered.

A relationship between the physical resource positions for two transmissions is:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t, Nt);

in a frequency domain, second_nf=first_nf+ceil(Nf/2);

where, second_nt is a physical resource position on the time domain for the second transmission, first_nt is a physical resource position on the time domain for the first transmission, second_nf is a physical resource position on the frequency domain for the second transmission, first_nt is a physical resource position on the frequency domain for the first transmission, shift_t is a shift parameter of a time domain unit, mod represents a modulo operation, and ceil(Nf/2) is a frequency domain offset.

When the number of the frequency domain SA resource units of the resource pool or the resource group is Nf and Nf is an odd number, the physical resource positions for initial transmission and retransmission of the SA information are fixed and located at different time domain sub-frame and frequency domain positions, and the determination unit is arranged to:

locate unpaired odd rows in the middle of a first frequency domain resource or a last frequency domain resource or section in frequency domain resources, and take a frequency domain SA resource unit remained after even rows are paired, herein the physical resource positions for two transmissions satisfy the following relationship:

on a time domain resource: the physical resource position second_nt on the time domain for the second transmission is the sum of the physical resource position first_nt on the time domain for the first transmission and the frequency domain offset ceil(Nf/2);

on a frequency domain resource: the physical resource position second_ft on the frequency for the second transmission is identical to the physical resource position first_ft on the frequency domain for the first transmission.

When Nf is an odd number, after an odd row position is determined, the relationship between the physical resource positions for two transmissions is that:

a frequency domain SA resource unit remained after even rows are paired is located in the middle of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2);

or, a frequency domain SA resource unit remained after even rows are paired is located at a tail or tail row of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2);

where, shift_t is a shift parameter of a time domain unit, and shift_f is a shift parameter of a frequency domain unit; mod represents a modulo operation; and when a resource group mode is adopted, shift_t is less than Nt/2.

When the number of frequency domain SA resource units of the resource pool or the resource group is Nf and the number of time domain SA resource units is Nt, the physical resource positions for initial transmission and retransmission of the SA information are fixed and located at different time domain sub-frame and frequency domain positions, and the determination unit is arranged to:

locate the physical resource position for one transmission in the resource pool or the resource group (first_nt, first_nf), and locate the opposite physical resource position for the other transmission in the resource pool or the resource group (second_nt, second_nf), herein the physical resource positions for two transmissions satisfy the following relationship:

in a time domain,

as for a clockwise cycle mode,

second_nt=mod[Nt+first_nt+floor(first_nf/(2×shift_f))×shift_f+mod(first_nf,shift_f)−shift_t,Nt];

as for an anticlockwise cycle mode,

second_nt=mod[first_nt+floor(first_nf/(2*shift_f))×shift_f+mod(first_nf,shift_f)+shift_t, Nt]; and

in a frequency domain, second_nt=first_nt+shift_f−floor[(first_nf+shift_f)/Nf]×[1+mod(first_nf,shift_f)];

where, shift_t is a shift parameter of a time domain unit, and shift_f is a shift parameter of a frequency domain unit; and mod represents a modulo operation, and floor is rounding down.

When Nf is an odd number, a row of frequency resources is remained after pairing, the physical resource position for one transmission is located at a front part of Nt, and the physical resource position for the other transmission is located at a rear part of Nt. The physical resource positions for two transmissions satisfy the following relationship:

in a time domain, second_nt=first_nt+ceil(Nt/2); and

in a frequency domain, second_nf=first_nf.

The resource configuration information of the SA information for the D2D communication includes:

a logical channel indication for indicating a physical resource position of each logical channel in the resource pool;

or, the resource configuration information includes a logical channel indication for indicating a physical resource position of each logical channel in the resource pool and a resource group indication.

The logical channel indications are sorted in accordance with a configured physical resource frequency, or time or intervals.

The processing unit is arranged to:

select a resource according to a resource group indication in the resource pool included in the determined resource configuration information of the SA information for the D2D communication and a logical channel indication of a logical channel corresponding to the resource group; or select a resource according to a logical channel indication of a logical channel corresponding to the resource pool included in the determined resource configuration information of the SA information for the D2D communication; or, select a resource according to position information in the time domain for initial transmission and retransmission and position information in the frequency domain for initial transmission; and

carry out D2D communication processing according to the selected resource.

The apparatus is arranged at an eNB or arranged at a D2D UE.

A computer-readable storage medium stores a computer-executable instruction. The computer-executable instruction is used for executing any one of the above-mentioned methods.

Compared with the conventional art, the technical solution of the present application includes that: resource configuration information of SA information for a D2D communication is determined in accordance with a preset policy for determining a positional relationship between an initial transmission resource unit and a retransmission resource unit; and a resource is acquired according to the determined resource configuration information of the SA information, and D2D communication processing is carried out. By determining a positional relationship between an initial transmission resource unit and a retransmission resource unit according to the method in the embodiments of the present disclosure, the problem of restriction of duplexity on mutual monitoring between UEs is avoided, and the D2D UE is ensured to monitor successfully SA.

### BRIEF DESCRIPTION OF DRAWINGS

FIG. 1 is a flowchart of a D2D processing implementation method according to an embodiment of the present disclosure.

FIG. 2 is a composition connection diagram of a D2D processing implementation apparatus according to an embodiment of the present disclosure.

FIG. 3(a) is a schematic diagram of a first SA pattern in a first embodiment of the present disclosure.

FIG. 3(b) is a schematic diagram of a second SA pattern in a first embodiment of the present disclosure.

FIG. 3(c) is a schematic diagram of a third SA pattern in a first embodiment of the present disclosure.

FIG. 3(d) is a schematic diagram of a fourth SA pattern in a first embodiment of the present disclosure.

FIG. 4(a) is a schematic diagram of a first SA pattern in a second embodiment of the present disclosure.

FIG. 4(b) is a schematic diagram of a second SA pattern in a second embodiment of the present disclosure.

FIG. 4(c) is a schematic diagram of a third SA pattern in a second embodiment of the present disclosure.

FIG. 4(d) is a schematic diagram of a fourth SA pattern in a second embodiment of the present disclosure.

FIG. 5 is a schematic diagram of SA in a third embodiment of the present disclosure.

FIG. 6(a) is a schematic diagram of first SA in a fourth embodiment of the present disclosure.

FIG. 6(b) is a schematic diagram of second SA in a fourth embodiment of the present disclosure.

FIG. 6(c) is a schematic diagram of third SA in a fourth embodiment of the present disclosure.

### DETAILED DESCRIPTION

The preferred embodiments of the present disclosure will be illustrated herein below in combination with the accompanying drawings. It is important to note that the embodiments in the present disclosure and the features in the embodiments may be combined without conflicts.

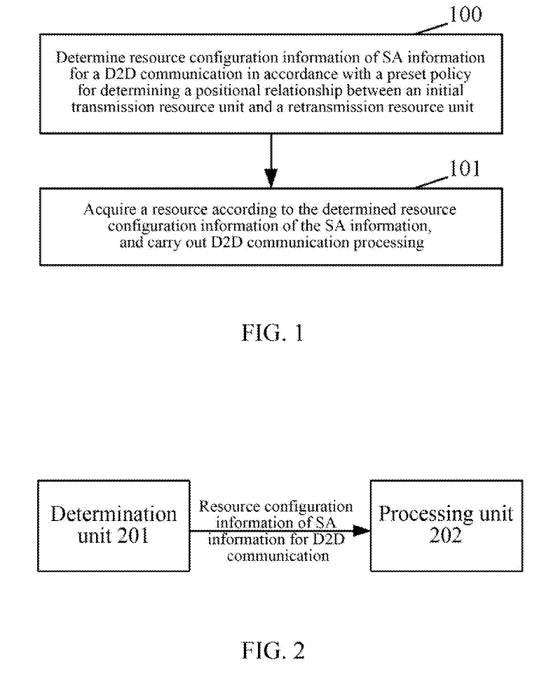

FIG. 1 is a flowchart of a D2D processing implementation method according to an embodiment of the present disclosure. As shown in FIG. 1, the method includes the following steps.

Step 100: Resource configuration information of SA information for a D2D communication is determined in accordance with a preset policy for determining a positional relationship between an initial transmission resource unit and a retransmission resource unit.

In the embodiments of the present disclosure, a resource of the SA information for the D2D communication includes X SA resource units composed of (Nf frequency domain SA resource units×Nt time domain SA resource units); and the size of each SA resource unit is a PRB pair, that is, a sub-frame is included in a time domain, and 12 sub-carriers are included in a frequency domain. The X SA resource units are used for configuring T logical channels, a physical resource position of each logical channel being determined according to a sending count and the preset policy for determining the positional relationship between the initial transmission resource unit and the retransmission resource unit. Herein, Nt represents the number of SA resource time domain units contained within an SA period. If an SA resource unit is a PRB pair, the time is a sub-frame, then Nt is the number of SA sub-frames contained within an SA period. That is to say, Nt represents a maximum number of time domain SA resources within an SA period. Nf represents a maximum SA frequency resource number of Mode1 or Mode2 contained in the given SA sub-frames. If an SA resource unit is a PRB pair, the frequency is 12 sub-carriers. That is to say, Nf represents a maximum number of frequency domain SA resources within an SA period. The sending count comprises first sending namely initial transmission and second sending namely retransmission.

Herein, the resource of the SA information for the D2D communication may be a resource pool or may be a resource pool composed of M resource groups. Herein, M is the number of frequency resource sections grouped in accordance with a preset grouping principle. Here, the grouping principle may include, but is not limited to, that: frequency resources of the resource pool may be divided in accordance with the size of Nt during division of the resource groups, that is, M (Nt−1,Nt) resource groups and an ([Nf−(Nt−1)*(M−1)],Nt) resource group are divided; or, division is performed according to an equal division principle, that is, M (Nf,Nt) resource groups are divided, where Nf<Nt; or, maximum resources supported by SA within an SA period are a unit, and are ungrouped. If four sub-frames are configured within an SA period, a PRB maximally configured by model is 24PRB, eight divided resource group structures are [3,4], and ungrouped resource structures are [24,4]. If eight sub-frames are configured within an SA period, a PRB maximally configured by model is 12PRB, two [6,8] resource groups may be configured in accordance with an equal division principle, and ungrouped resource structures are [12,8].

If the resource of the SA information for the D2D communication is a resource pool, X SA resource units composed of (Nf frequency domain SA resource units×Nt SA time domain resource units) are included; and the size of each SA resource unit is a PRB pair, that is, a sub-frame is included in a time domain, and 12 sub-carriers are included in a frequency domain. The X SA resource units are used for configuring T logical channels, a physical resource position of each logical channel in the resource pool being determined according to a sending count and the preset policy for determining the positions of the initial transmission resource unit and the retransmission resource unit.

If the resource of the SA information for the D2D communication is M resource groups, each resource group includes: X SA resource units composed of (Nf frequency domain SA resource units×Nt SA time domain resource units); and the size of each SA resource unit is a PRB pair, that is, a sub-frame is included in a time domain, and 12 sub-carriers are included in a frequency domain. X SA resource units in each resource group are used for configuring T logical channels, a physical resource position of each logical channel in the resource group being determined according to a sending count and the preset policy for determining the positions of the initial transmission resource unit and the retransmission resource unit.

As above, the frequency domain SA resource units in the resource pool or the resource group may be continuously assigned or discontinuously assigned; and the time domain SA resource units in the resource pool or the resource group are continuously assigned or discontinuously assigned.

In the present step, the policy for determining the positional relationship between the initial transmission resource unit and the retransmission resource unit is that:

The physical resource positions for initial transmission and retransmission of the SA information are fixed, and located at different time domain sub-frame and frequency domain positions. Nt sending data located at a position on a frequency domain resource for one transmission first_nf in the resource pool or resource group is on a frequency domain resource shifted on the basis of a position in a time domain for one transmission first_nt and a position in a frequency domain for the other transmission first_nf, and a resource position of a time frequency resource Nt shifted cyclically leftwards or rightwards is a sending position of the other opposite resource. Herein,

The policy for determining the positional relationship between the initial transmission resource unit and the retransmission resource unit is that:

When the number of the frequency domain SA resource units of the resource pool or the resource group is Nf and Nf is an even number, the physical resource position for one transmission is located at an upper frequency band of the resource pool or the resource group, and the physical resource position for the other transmission is located at a lower frequency band or is configured in accordance with a preset frequency offset as long as position staggered is guaranteed. A relationship between the physical resource positions for two transmissions is:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t, Nt);

in a frequency domain, second_nf=first_nf+ceil(Nf/2).

When Nf is an odd number, since unpaired odd rows may be located in the middle of a first frequency domain resource or a last frequency domain resource or section in frequency domain resources, a frequency domain SA resource unit remained after even rows are paired is taken, and the physical resource positions for two transmissions satisfy the following relationship:

on a time domain resource: the physical resource position second_nt on the time domain for the second transmission is the sum of the physical resource position first_nt on the time domain for the first transmission and the frequency domain offset ceil(Nf/2), that is, second_nf=first_nf+ceil(Nf/2); and on a frequency domain resource: the physical resource position second_ft on the frequency domain for the second transmission is identical to the physical resource position first_ft on the frequency domain for the first transmission, that is, second_nf=first_nf.

When Nf is an odd number, an odd line position is determined, then two-by-two pairing is performed according to the following formula, and the relationship between the physical resource positions for two transmissions is that:

a frequency domain SA resource unit remained after even rows are paired is located in the middle of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2).

Or, a frequency domain SA resource unit remained after even rows are paired is located at a tail or tail row of a frequency band, and the physical resource positions for two transmissions satisfy the following relationship:

in a time domain,

as for a clockwise cycle mode, second_nt=mod(Nt+first_nt+first_nf−shift_t,Nt);

as for an anticlockwise cycle mode, second_nt=mod(first_nt+first_nf+shift_t,Nt);

in a frequency domain, second_nf=first_nf+ceil(Nf/2).

Or, the policy for determining the positional relationship between the initial transmission resource unit and the retransmission resource unit is that:

when the number of frequency domain SA resource units of the resource pool or the resource group is Nf and the number of time domain resources is Nt, the physical resource position for one transmission is located in the resource pool or the resource group (first_nt, first_nf), the opposite physical resource position for the other transmission is located in the resource pool or the resource group (second_nt, second_nf), and the physical resource positions for two transmissions satisfy the following relationship:

in a time domain,

in a time domain,

as for a clockwise cycle mode, second_nt=mod[Nt+first_nt+floor(first_nf/(2×shift_f))×shift_f+mod(first_nf,shift_f)−shift_t,Nt], that is, reverse cycle;

as for an anticlockwise cycle mode, second_nt=mod[first_nt+floor(first_nf/(2*shift_f))×shift_f+mod(first_nf,shift_f)+shift_t,Nt], that is, forward cycle;

in a frequency domain,

second_nt=first_nt+shift_f−floor[(first_nf+shift_f)/Nf]×[1+mod(first_nf,shift_f)];

where, a floor operator represents round-off of a minimum integer.

The above three formulae are equivalent to:

when retransmission does not exceed Nf, in a frequency domain, second_nf=first_nf+shift_f;

when retransmission exceeds Nf, in a frequency domain, second_nf=first_nf+shift_f−[1+mod(first_nf,shift_f)];

when Nf is an odd number (i.e., the last remaining row),

in a time domain, second_nt=(first_nt+Nt/2), and in a frequency domain, second_nf=first_nf.

When Nf is an odd number, after pairing is performed in accordance with the above pairing modes namely formulae, a row of frequency resources is remained after pairing, the physical resource position for one transmission is located at a front part of Nt, and the physical resource position for the other transmission is located at a rear part of Nt. The physical resource positions for two transmissions satisfy the following relationship:

in a time domain, second_nt=first_nt+ceil(Nt/2); and

in a frequency domain, second_nf=first_nf.

As above, shift_t is a shift parameter of a time domain unit, shift_f is a shift parameter of a frequency domain unit, and mod represents a modulo operation. Grouping of the resource pool adopts a frequency resource division mode shift_t is smaller than Nt/2; when the resource pool is not grouped, Nf is a maximum frequency resource number of Mode1 or Mode2 of a frequency resource pool within one SA period; and when the resource pool is grouped, Nf is a maximum frequency resource number of frequency resources of the resource group.

In the present step, the physical resource position of each logical channel in the resource pool or the resource group may be determined according to the preset policy for determining the positional relationship between the initial transmission resource unit and the retransmission resource unit, thereby determining the resource configuration information of the SA information for the D2D communication, including a logical channel indication for indicating a physical resource position of each logical channel in the resource pool, or including a logical channel indication for indicating a physical resource position of each logical channel in the resource group and a resource group indication. Herein, the logical channel indications may be sorted in accordance with a configured physical resource frequency, or time or intervals.

Step 101: A resource is acquired according to the determined resource configuration information of the SA information, and D2D communication processing is carried out. The step includes that:

Firstly, a resource is selected according to a resource group indication in the resource pool included in the determined resource configuration information of the SA information for the D2D communication and a logical channel indication of a logical channel corresponding to the resource group; or a resource is selected according to a logical channel indication of a logical channel corresponding to the resource pool included in the determined resource configuration information of the SA information for the D2D communication; or, a resource is selected according to position information in the time domain for initial transmission and retransmission and position information in the frequency domain for initial transmission; and then, D2D communication processing is carried out according to the selected resource.

In the method according to the embodiments of the present disclosure, the resource configuration information of the SA information for the D2D communication may be determined by an eNB and then sent to a D2D UE. Or, the D2D UE may monitor and acquire the resource for the D2D communication.

FIG. 2 is a composition connection diagram of a D2D processing implementation apparatus according to an embodiment of the present disclosure. As shown in FIG. 2, the apparatus includes a determination unit 201 and a processing unit 202, herein

The determination unit 201 presets a preset policy for determining a positional relationship between an initial transmission resource unit and a retransmission resource unit, and is arranged to determine resource configuration information of SA information for a D2D communication according to the policy; and

The processing unit 203 is arranged to acquire a resource according to the determined resource configuration information of the SA information, and carry out D2D communication processing.

The D2D processing implementation apparatus according to the embodiments of the present disclosure may be arranged at an eNB or may be arranged at a D2D UE.

Detailed description will be made below with the embodiments.

First embodiment: it is supposed that a time domain resource includes eight sub-frames and a frequency resource of a resource pool includes four PRBs, which are equally partitioned by a frequency domain and grouped two by two. In the first embodiment, serial number arrangement may be time arrangement, or may be frequency direction arrangement, serial numbers may be arranged in any mode after forming a pattern in accordance with a formula for dividing the frequency into an upper band and a lower band, and then the position of a time frequency resource is determined according to the serial numbers.

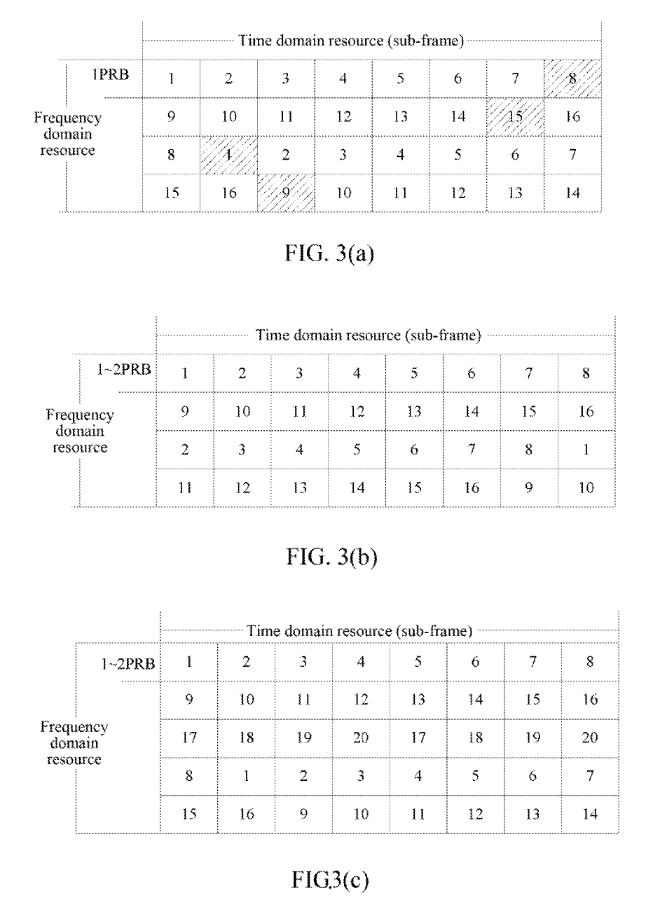

FIG. 3(a) is a schematic diagram of a first SA pattern in a first embodiment of the present disclosure. Herein, a frequency domain is an even number of SA resource units, a positional relative relationship is over an upper frequency band and a lower frequency band, and the schematic diagram is an SA pattern diagram of anticlockwise cycle of the SA resource units. As for an anticlockwise cycle mode,

in a time domain, second_nt=mod(first_nt+first_nf+shift_t, Nt);

in a frequency domain, second_nf=first_nf+ceil(Nf/2);

where, shift_t=1.

As shown in FIG. 3(a), the frequency is divided into an upper frequency band and a lower frequency band, the first row and the third row are distributed into a group, the second row and the fourth row are distributed into a group, the third row and the fourth row are corresponding positions of serial numbers after cycle shift, and 1, 9, 8 and 15 corresponding to the serial numbers are located at different sub-frames after shifting in accordance with a policy for determining a positional relationship between an initial transmission resource unit and a retransmission resource unit in the embodiments of the present disclosure (as shown in hatching lines in FIG. 3(a)). It is important to note that the serial numbers here are merely intended to mark position information in an SA resource pool, and after a pattern is formed, that is, a relationship between two physical resources corresponding to a logical resource is determined, different marks may be adopted.

FIG. 3(b) is a schematic diagram of a second SA pattern in a first embodiment of the present disclosure. Herein, a frequency domain is an even number of SA resource units, a positional relative relationship is over an upper frequency band and a lower frequency band, and the schematic diagram is an SA pattern diagram of clockwise cycle of the SA resource units. As for a clockwise cycle mode,

in a time domain, second_nt=mod(first_nt+first_nf+shift_t, Nt);

in a frequency domain, second_nf=first_nf+ceil(Nf/2);

where, shift_t=1.

FIG. 3(c) is a schematic diagram of a third SA pattern in a first embodiment of the present disclosure. Herein, a frequency domain is an odd number of SA resource units, a positional relative relationship is over an upper frequency band and a lower frequency band, and after the SA resource units are paired in anticlockwise cycle, the remaining odd lines are located in the middle of the frequency resource. As for an anticlockwise cycle mode,

in a time domain, second_nt=mod(first_nt+first_nf+shift_t, Nt);

in a frequency domain, second_nf=first_nf+ceil(Nf/2);

where, shift_t=1.

As shown in FIG. 3(c), the remaining odd lines are located in the middle of the frequency resource.

FIG. 3(d) is a schematic diagram of a fourth SA pattern in a first embodiment of the present disclosure. Herein, a frequency domain is an odd number of SA resource units, a positional relative relationship is over an upper frequency band and a lower frequency band, after a pattern is generated in anticlockwise cycle of the SA resource units, all SA frequency resources of the first sub-frame are arranged in a sub-frame order according to serial numbers, SA frequency resources of the second sub-frame are arranged, and the serial numbers may start from 0. As shown in FIG. 3(d), a positional relationship between physical resources is marked. For example, a logical serial number 1 is located at a first frequency position of the first sub-frame of a time domain resource in a resource pool or a resource group and a third frequency position of the second sub-frame. Certainly, the serial numbers and the positional relationship may be 0-N.

Second embodiment: it is supposed that any frequency domains are spaced into pairs, in a time domain,

as for a clockwise cycle mode, second_nt=mod[Nt+first_nt+floor(first_nf/(2×shift_f))×shift_f+mod(first_nf,shift_f)−shift_t,Nt], that is, reverse cycle;

as for an anticlockwise cycle mode, second_nt=mod[first_nt+floor(first_nf/(2*shift_f))×shift_f+mod(first_nf,shift_f)+shift_t,Nt], that is, forward cycle;

in a frequency domain,

second_nt=first_nt+shift_f−floor[(first_nf+shift_f)/Nf]×[1+mod(first_nf,shift_f)];

where, a floor operator represents round-off of a minimum integer.

The above three formulae are equivalent to:

when retransmission does not exceed Nf, in a frequency domain, second_nf=first_nf+shift_f;

when retransmission exceeds Nf, in a frequency domain, second_nf=first_nf+shift_f−[1+mod(first_nf,shift_f)];

when Nf is an odd number (i.e., the last remaining row),

in a time domain, second_nt=(first_nt+Nt/2), and in a frequency domain, second_nf=first_nf.

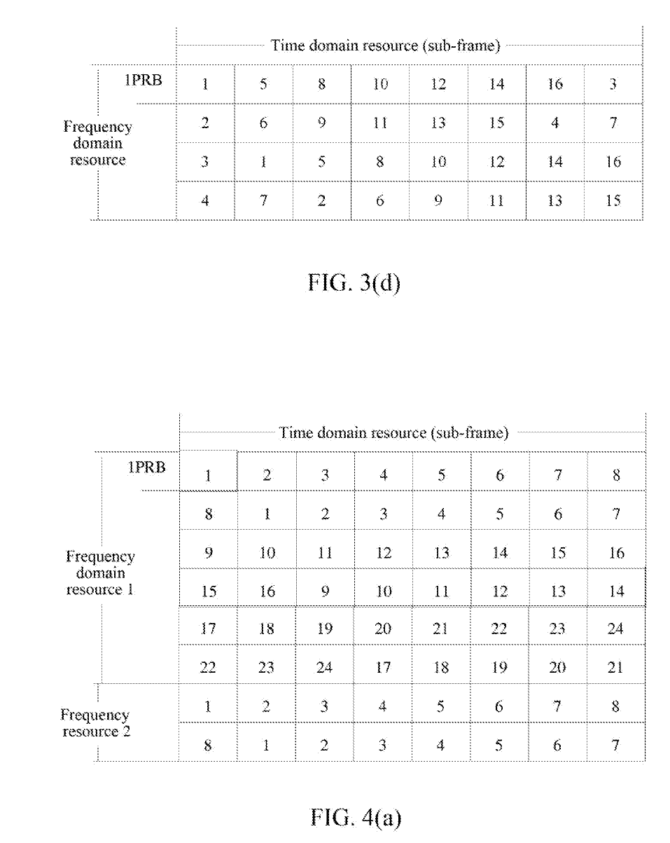

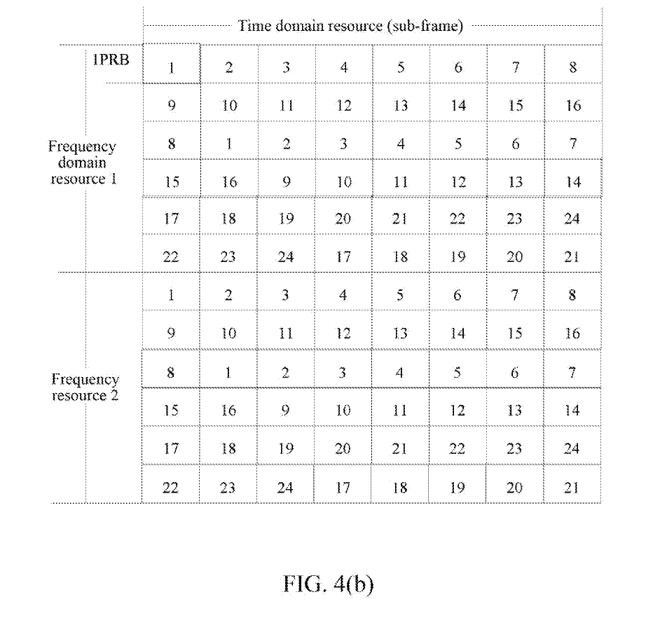

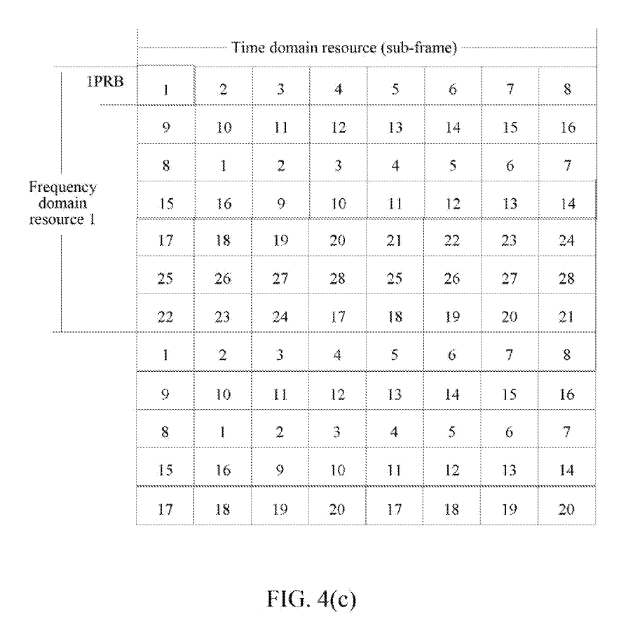

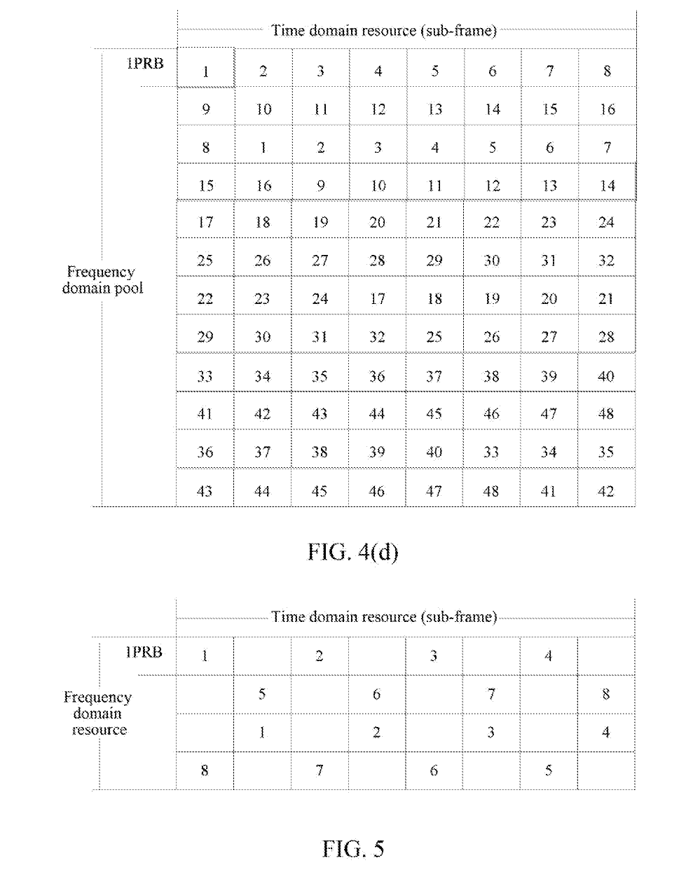

It is supposed that users in shift_f=1, Nt=8, Nf=6 resource groups may monitor each other, the first row and the second row are paired, the third row and the fourth row are paired, a pattern is formed after shifting in accordance with a principle, and the structure is as shown in FIG. 4(a). FIG. 4(a) is a schematic diagram of a first SA pattern in a second embodiment of the present disclosure. Herein, frequency grouping pairing is performed on the basis of that an even number of SA frequency units are smaller than time domain units, and M-1 groups are formed. Herein, after one group is paired according to the remaining frequency resources, a position pattern is generated according to a formula shift_f=1, the pairing principle referring to odd-even pairing instead of pairing of an upper frequency band and a lower frequency band.

As shown in FIG. 4(a), it is supposed that users in a shift_f=2 resource group may monitor each other. As shown in FIG. 4(b), the first row and the third row are paired, the second row and the fourth row are paired, a pattern is formed after shifting in accordance with a principle, and the structure is as shown in FIG. 4(b), where it can be divided into group inside pattern index and resource group indication according to resource indication for grouping. FIG. 4(b) is a schematic diagram of a second SA pattern in a second embodiment of the present disclosure. Herein, frequency grouping pairing is performed on the basis of that SA frequency units are smaller than time domain units, and M-1 groups are formed. Herein, after one group is paired according to the remaining frequency resources, a position pattern is generated according to a formula shift_f=2, the pairing principle referring to odd-even pairing instead of pairing of an upper frequency band and a lower frequency band.

The frequency resources are equally divided into six PRBs, and then two PRB frequency bands are remained. Herein, the grouped resources are arranged in accordance with a principle to form a logical unit. Eight sub-frames contain 24 patterns, and 5 bit instructions may be used. As shown in FIG. 4(a), the frequency resources have eight PRBs divided into two bands and indicated by 1 bit. For example, 000001 indicates a resource position of index 2 in a first frequency band, a high level is a frequency partition indication, a low level is a logical resource serial number, each logical resource occupies two physical resource units, and the position is determined by means of the position in an SA resource pool group. That is, 6 bits are used to indicate the positions of SA resources in the resource pool. Absolutely, if there are more frequency resources, the resources may be equally divided into a plurality of resource sections by taking 6 PRBs as a group, and more bits are used to indicate the frequency resources. That is, an SA resource indication is divided into two parts, and the overhead is 6 bit according to time frequency resources, as shown in Table (1):

TABLE 1

| | Overhead | Description |
|---|---|---|
| Resource grouping | 1-3 | Indicate SA resource pool |
| indication | | frequency partition |
| SA index | 3-5 | Indicate SA index |

It is supposed that a frequency interval is 1, that is, shift_f=2, and grouping is not performed. When the number of frequency domain PRBs is greater than the number of time domain sub-frames, the situation that some D2D UEs cannot monitor each other may exist, and PRB cycle is performed at different frequencies according to a time offset shift_t=1.

At this time, a pattern indication is an indication after all resources are sorted in accordance with a principle. As shown in FIG. 4(d), FIG. 4(d) is a schematic diagram of a fourth SA pattern in a second embodiment of the present disclosure. Herein, frequency units are not grouped, a position pattern is generated according to a formula shift_f=2 in accordance with the number of frequency units of the resource pool within one SA period, the pairing principle referring to odd-even pairing instead of pairing of an upper frequency band and a lower frequency band. For example, all resources are sorted into 1 to 48 SA resource units, and physical units indicated by two physical resources 11000 corresponding to 25 are used physical units, located in the sixth row of the first sub-frame and the eighth row of the fifth sub-frame.

Likewise, a maximum unit pool of the given sub-frame may be divided according to [7,8] structure. The first section is a first resource group, remaining resources are a second section namely a second resource group, and serial numbers may be arranged according to serial numbers of the resources of the first section, i.e., arranged from 1. As shown in FIG. 4(c), FIG. 4(c) is a schematic diagram of a third SA pattern in a second embodiment of the present disclosure. Herein, frequency grouping pairing is performed on the basis of that SA frequency units are smaller than time domain units, and M-1 groups are formed. Herein, after one group is paired according to the remaining frequency resources, a position pattern is generated according to a formula shift_f=2, the pairing principle referring to odd-even pairing instead of pairing of an upper frequency band and a lower frequency band.

It is supposed that a maximum unit pool of the given sub-frame within an SA period is divided according to [6,8] structure. As shown in FIG. 4(b), in the first, second, third and fourth rows, shift_f=2, and in the fifth and sixth rows, shift_f=1, and shift_t=1.

Third embodiment: the present embodiment is used for describing a resource indication method.

(1) An SA resource pool is configured in accordance with a preset principle. For example, the SA resource pool has 128 physical resource units, 64 logical resource positions may be determined according to frequency domain resource pairing and time domain cycle shifting or according to a principle of mutual monitoring as far as possible in a resource, and 6 bit indication is needed.

(2) Serial numbers namely logical resources do not fully occupy all physical resources. As shown in FIG. 5, FIG. 5 is a schematic diagram of SA in a third embodiment of the present disclosure. Herein, some SA resource units within an SA period are only sorted according to a principle, that is, only some SA resource units are applicable. Thus, it is ensured that all users may monitor each other when the resource pool is large enough. For example, the SA resource pool has 256 physical resource units arranged in a staggered manner in odd rows and even rows, and has 128 physical resource units, 64 logical resource positions may be determined according to a principle of frequency domain resource pairing and time domain cycle shifting or according to a principle of mutual monitoring as far as possible in a resource, and 6 bit indication is needed.

(3) The resource pool is grouped, the grouping principle referring to that the number of frequency resources in the groups may be determined according to the number of time domain sub-frames. For example, each SA resource pool may be divided into frequency resources according to the number of sub-frames. If the number of sub-frames is 4 and the number of frequency resources in the resource group is 3, the number of patterns of each resource group is 6 occupying 3 bits. In addition, 3 bit is a resource group indication capable of indicating 8 resource groups, the size of the resource pool thereof is 4×8×3=96 physical resource units, and 48 logical resource units are indicated by using 6 patterns and a corresponding resource group respectively.

For another example, the number of sub-frames is 8, as shown in FIG. 4(b), grouping is performed when the number of frequency resources is 7, the number of patterns of each resource group is 28, and two resource groups are formed. If both the two resource groups are 7PRB, the size of the resource pool is 8×7×2=112 physical resource units, and the group of 56 logical resource units may be indicated by using 1 bit, and logical channels may be 5 bit, capable of indicating the positions of logical resources in the resource pool.

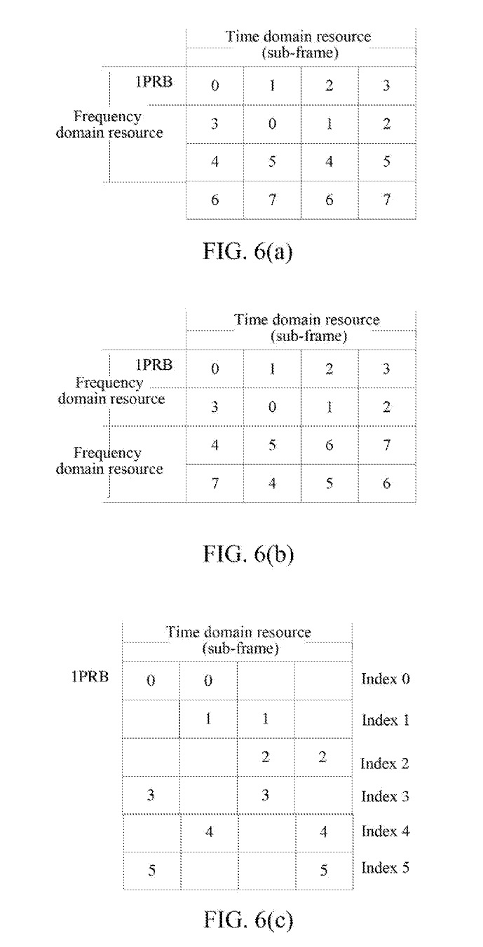

(4) FIG. 6(c) is a schematic diagram of third SA in a fourth embodiment of the present disclosure. Herein, a grouping and indication principle refers to that: patterns which do not monitor each other are formed according to the principle, a pattern is arranged according to different time domain positions, and a first frequency position, a relative relationship and the serial numbers of the patterns are indicated. As shown in FIG. 6(c), a time domain pattern is 6 at four sub-frames, a frequency hopping mode may be fixed, and a logical channel position is indicated by indicating a first frequency position, the serial numbers of the patterns and a frequency hopping pattern. As shown in FIG. 6(c), frequency hopping is 0, that is, the second frequency position is the same as the first frequency position, and it may be obtained that the second physical unit is at the first PRB and the second sub-frame by indicating a pattern 0 and a relative position of the frequency in the resource pool.

If division is performed according to maximum groups which cannot monitor each other, remaining groups of the resource pool cannot contain maximum frequency resources. For example, the number of the remaining frequency resources is 2, and patterns of the remaining resources are arranged according to the principle and indicated.

Fourth embodiment: in the present embodiment, it is supposed that a pattern is composed according to time domain distribution resources, and a frequency domain adopts a frequency hopping mode, as shown in FIG. 6(a). FIG. 6(a) is a schematic diagram of first SA in a fourth embodiment of the present disclosure. Here, the grouping and indication principle refers to: grouping based on that a frequency domain SA resource unit is smaller than a time domain SA resource unit, and dividing the remaining resources into a group. As shown in FIGS. 6(a), 6 and 7 form a pattern, and are repeated with 4 and 5. Therefore, when the number of sub-frames is 4, there are six patterns which may not be repeated, as shown in FIG. 6(c). The frequency hopping mode may be fixed frequency hopping in an SA resource pool, second_nf=mod(first_nf+shift_f+subframe,Nf). When the number of sub-frames is configured as 0, shift may be divided into an upper part and a lower part according to the size of the resource pool, shift_f=Nf/2; or, the number of sub-frames is obtained by a system, and may be the number of sub-frames of D2D.

If a grouping method is adopted, the grouping structure is 4×3 and 4×1 or two 4×2, after grouping according to number of sub-frames×(number of sub-frames-1), the remaining frequency domain resources are distributed into a group, as shown in FIG. 6(b). Or, the resources are equally divided according to the number of frequency domain resources, as shown in FIG. 6(b). FIG. 6(b) is a schematic diagram of second SA in a fourth embodiment of the present disclosure. Here, the grouping and indication principle refers to a grouping principle that frequency domain SA resource units are smaller than time domain units and the frequency domain SA resource units are equally divided. Herein, Nf<number of sub-frames.

It may be seen that two users cannot monitor each other if resources are divided according to (Nt−1), Nt and four users cannot monitor each other if resources are divided equally. That is to say, all divisions only ensure mutual monitoring within Nf<Nt after grouping when Nf>Nt. Therefore, the number of users monitoring each other is maximally ensured according to [Nt−1,Nt] grouping in the embodiments of the present disclosure. Some users cannot monitor each other as for non-grouping of the resource pool such as Nf>Nt. Therefore, a user group is selected to the greatest extent according to distribution of users needing to monitor each other during grouping.

In the method according to the embodiments of the present disclosure, a logical resource indication method is determined as global indication, divided into the following three methods:

Serial numbers of logical resources are indicated after resource pools are sorted according to a predetermined principle, as shown in FIG. 4(d).

Or, the resource pools are grouped, grouping information and logical resource serial numbers in the resource groups are indicated, and the grouping method includes: equally dividing frequency resources according to frequency groups determined by time domain sub-frames such as time domain sub-frames, as shown in FIG. 4(b). For example, according to the time domain sub-frames, the frequency resources are smaller than the time domain sub-frames namely Nf=Nt−1, as shown in FIG. 4(c).

Or, the number of available patterns and the serial numbers are determined according to location at different sub-frames during one of two transmissions and the number of sub-frames contained within an SA period, as shown in FIG. 6(c). The physical unit positions of the logical resources are determined according to frequency domain indication information and a frequency hopping solution.

Those of ordinary skill in the art may understand that all or some of the steps of the above-mentioned embodiment may be implemented by using a computer program flow. The computer program may be stored in a computer-readable storage medium. The computer program is executed on a corresponding hardware platform (such as system, equipment, apparatus, and device). During execution, the computer program includes one of the steps of the method embodiment or a combination thereof.

Alternatively, all or some of the steps of the above-mentioned embodiment may also be implemented by using an integrated circuit. These steps may be manufactured into integrated circuit modules respectively, or a plurality of modules or steps herein are manufactured into a single integrated circuit module.

Each apparatus/functional module/function unit in the above-mentioned embodiment may be implemented by using a general computation apparatus. They may be centralized on a single computation apparatus or may be distributed on a network composed of a plurality of computation apparatuses.

When each apparatus/functional module/function unit in the above-mentioned embodiment is implemented in a form of a software function module and is sold or used as an independent product, the product may also be stored in a computer-readable storage medium. The above-mentioned computer-readable storage medium may be a read-only memory, a magnetic disk or an optical disk.

### INDUSTRIAL APPLICABILITY

By determining a positional relationship between an initial transmission resource unit and a retransmission resource unit according to the method in the embodiments of the present disclosure, the problem of restriction of duplexity on mutual monitoring between UEs is avoided, and it is ensured that a D2D UE may monitor SA of the D2D UE, simultaneously sent, at other moments.

1. A method for implementing Device-to-Device (D2D) processing, comprising:
determining resource configuration information of Scheduling Assignment (SA) information for a D2D communication in accordance with a preset policy for determining a positional relationship between an initial transmission resource unit and a retransmission resource unit; and
acquiring a resource according to the determined resource configuration information of the SA information, and carrying out D2D communication processing.

2. The method according to claim 1, wherein the resource of the SA information for the D2D communication comprises:
X SA resource units composed of (Nf frequency domain SA resource units×Nt SA time domain resource units), size of each SA resource unit being one PRB pair;
the X SA resource units are used for configuring T logical channels, a physical resource position of each logical channel being determined by each logical channel according to a sending count and the preset policy for determining the positional relationship between the initial transmission resource unit and the retransmission resource unit;
wherein, Nt represents a maximum number of time domain SA resources within one SA period, and Nf represents a maximum number of frequency domain SA resources.

3. The method according to claim 2, wherein the resource is a resource pool or a resource group within one SA period.

4. The method according to claim 3, wherein the frequency domain SA resource units in the resource pool or the resource group are continuously assigned or discontinuously assigned; and
the time domain SA resource units in the resource pool or the resource group are continuously assigned or discontinuously assigned.

5. The method according to claim 3, wherein the policy for determining the positional relationship between the initial transmission resource unit and the retransmission resource unit is that:
the physical resource positions for initial transmission and retransmission of the SA information are fixed, and located at different time domain sub-frame and frequency domain positions.

6. The method according to claim 5, wherein when the number of the frequency domain SA resource units of the resource pool or the resource group is Nf and Nf is an even number, the physical resource positions for initial transmission and retransmission of the SA information being fixed and located at different time domain sub-frame and frequency domain positions comprises that:
the physical resource position for one transmission is located at an upper frequency band of the resource pool or the resource group, and the physical resource position for the other transmission is located at a lower frequency band or is configured in accordance with a preset frequency offset, thereby ensuring position staggered;
a relationship between the physical resource positions for two transmissions of the initial transmission and retransmission is:
in a time domain,
as for a clockwise cycle mode, second_nt=mod(Nt+first_nt+first_nf−shift_t, Nt);
as for an anticlockwise cycle mode, second_nt=mod(first_nt+first_nf+shift_t, Nt);
in a frequency domain, second_nf=first_nf+ceil(Nf/2);
where, second_nt is a physical resource position on the time domain for the second transmission, first_nt is a physical resource position on the time domain for the first transmission, second_nf is a physical resource position on the frequency domain for the second transmission, first_nf is a physical resource position on the frequency domain for the first transmission, shift_t is a shift parameter of a time domain unit, mod represents a modulo operation, and ceil(Nf/2) is a frequency domain offset.

7. The method according to claim 5, wherein when the number of the frequency domain SA resource units of the resource pool or the resource group is Nf and Nf is an odd number, the physical resource positions for initial transmission and retransmission of the SA information being fixed and located at different time domain sub-frame and frequency domain positions comprises that:
a unpaired odd row is located in a first frequency domain resource or a last frequency domain resource or a middle of a section in frequency domain resources, one frequency domain SA resource unit remained after even rows are paired, and the physical resource positions for two transmissions of the initial transmission and retransmission satisfy the following relationship:
on a time domain resource: the physical resource position second_nt on the time domain for the second transmission is a sum of the physical resource position first_nt on the time domain for the first transmission and the time domain offset ceil(Nt/2);
on a frequency domain resource: the physical resource position second_ft on the frequency domain for the second transmission is identical to the physical resource position first_ft on the frequency domain for the first transmission.

8. The method according to claim 7, wherein when Nf is an odd number, after an odd row position is determined, the relationship between the physical resource positions for two transmissions is that:
one frequency domain SA resource unit remained after even rows are paired is located in the middle of a frequency band, and the physical resource positions for two transmissions satisfy the following relationship:
in a time domain,
as for a clockwise cycle mode, second_nt=mod(Nt+first_nt+first_nf−shift_t, Nt);
as for an anticlockwise cycle mode, second_nt=mod(first_nt+first of+shift_t, Nt);
in a frequency domain, second_nf=first_nf+ceil(Nf/2);
or, a frequency domain SA resource unit remained after even rows are paired is located at a tail or tail row of a frequency band, and the physical resource positions for two transmissions satisfy the following relationship:
in a time domain,
as for a clockwise cycle mode, second_nt=mod(Nt+first_nt+first_nf−shift_t, Nt);
as for an anticlockwise cycle mode, second_nt=mod(first_nt+first_nf+shift_t, Nt);
in a frequency domain, second_nf=first_nf+(Nf−1/2);
where, shift_t is a shift parameter of a time domain unit, and shift_f is a shift parameter of a frequency domain unit; mod represents a modulo operation; and when a resource group mode is adopted, shift_t is less than Nt/2.

9. The method according to claim 5, wherein when the number of frequency domain SA resource units of the resource pool or the resource group within one SA period is Nf and the number of time domain SA resource units is Nt, the physical resource positions for initial transmission and retransmission of the SA information being fixed and located at different time domain sub-frame and frequency domain positions comprises that:
the physical resource position for one transmission is located in the resource pool or the resource group (first_nt, first_nf), the physical resource position for the other transmission is located in the resource pool or the resource group (second_nt, second_nf), and the physical resource positions for two transmissions satisfy the following relationship:
in a time domain,
as for a clockwise cycle mode,
second_nt=mod[Nt+first_nt+floor(first_nf/(2×shift_f))×shift_f+mod(first_nf,shift_f)−shift_t, Nt];
as for an anticlockwise cycle mode,
second_nt=mod[first_nt+floor(first_nf/(2*shift_f))×shift_f+mod(first_nf,shift_f)+shift_t,Nt]; and
in a frequency domain,
second_nt=first_nt+shift_f−floor[(first_nf+shift_f)/Nf]×[1+mod(first_nf,shift_f)];
where, shift_t is a shift parameter of a time domain unit, and shift_f is a shift parameter of a frequency domain unit; and mod represents a modulo operation, and floor is rounding down.

10. The method according to claim 8, wherein when Nf is an odd number, one row of frequency resources is remained after pairing, the physical resource position for one transmission is located at a front part of Nt, and the physical resource position for the other transmission is located at a rear part of Nt, the physical resource positions for two transmissions satisfy the following relationship:
in a time domain, second_nt=first_nt+ceil(Nt/2); and
in a frequency domain, second_nf=first_nf.

11. The method according to claim 1, wherein the resource configuration information of the SA information for the D2D communication comprises:
a logical channel indication for indicating a physical resource position of each logical channel in the resource pool;
or, the resource configuration information comprises a logical channel indication for indicating a physical resource position of each logical channel in the resource group and a resource group indication.

12. (canceled)

13. The method according to claim 11, wherein said acquiring a resource according to the determined resource configuration information of the SA information and carrying out D2D communication processing comprises:
selecting a resource according to a resource group indication in the resource pool comprised in the determined resource configuration information of the SA information for the D2D communication and a logical channel indication of a logical channel corresponding to the resource group; or selecting a resource according to a logical channel indication of a logical channel corresponding to the resource pool comprised in the determined resource configuration information of the SA information for the D2D communication; or, selecting a resource according to position information in the time domain for initial transmission and retransmission and position information in the frequency domain for initial transmission; and
carrying out D2D communication processing according to the selected resource.

14. (canceled)

15. An apparatus for implementing Device-to-Device (D2D) processing, comprising a determination unit and a processing unit, wherein
the determination unit, in which a preset policy for determining a positional relationship between an initial transmission resource unit and a retransmission resource unit is preset, is arranged to determine resource configuration information of Scheduling Assignment (SA) information for a D2D communication according to the policy; and
the processing unit is arranged to acquire a resource according to the determined resource configuration information of the SA information, and carry out D2D communication processing.

16. The apparatus according to claim 15, wherein the resource of the SA information for the D2D communication comprises:
X SA resource units composed of (Nf frequency domain SA resource units×Nt SA time domain resource units), size of each SA resource unit being one PRB pair;
the X SA resource units being used for configuring T logical channels, a physical resource position of each logical channel being determined by each logical channel according to a sending count and the preset policy for determining the positional relationship between the initial transmission resource unit and the retransmission resource unit;
wherein, Nt represents a maximum number of time domain SA resources within one SA period, and Nf represents a maximum number of frequency domain SA resources.

17-19. (canceled)

20. The apparatus according to claim 15, wherein when the number of the frequency domain SA resource units of the resource pool or the resource group is Nf and Nf is an even number, the physical resource positions for two transmissions, initial transmission and retransmission, of the SA information are fixed and located at different time domain sub-frame and frequency domain positions, and the determination unit is arranged to:
locate the physical resource position for one transmission at an upper frequency band of the resource pool or the resource group, locate the physical resource position for the other transmission at a lower frequency band, or configure in accordance with a preset frequency offset, thereby ensuring position staggered;
a relationship between the physical resource positions for two transmissions is:
in a time domain,
as for a clockwise cycle mode, second_nt=mod(Nt+first_nt+first_nf−shift_t, Nt);
as for an anticlockwise cycle mode, second_nt=mod(first_nt+first_nf+shift_t, Nt);
in a frequency domain, second_nf=first_nf+ceil(Nf/2);
where, second_nt is a physical resource position on the time domain for the second transmission, first_nt is a physical resource position on the time domain for the first transmission, second_nf is a physical resource position on the frequency domain for the second transmission, first_nf is a physical resource position on the frequency domain for the first transmission, shift_t is a shift parameter of a time domain unit, mod represents a modulo operation, and ceil(Nf/2) is a frequency domain offset.

21. The apparatus according to claim 15, wherein when the number of the frequency domain SA resource units of the resource pool or the resource group is Nf and Nf is an odd number, the physical resource positions for two transmissions, initial transmission and retransmission, of the SA information are fixed and located at different time domain sub-frame and frequency domain positions, and the determination unit is arranged to:
locate a unpaired odd row in a first frequency domain resource or a last frequency domain resource or the middle of a section in frequency domain resources, one frequency domain SA resource unit remained after even rows are paired, wherein the physical resource positions for two transmissions of initial transmission and retransmission satisfy the following relationship:
on a time domain resource: the physical resource position second_nt on the time domain for the second transmission is a sum of the physical resource position first_nt on the time domain for the first transmission and the frequency domain offset ceil(Nt/2);
on a frequency domain resource: the physical resource position second_ft on the frequency domain for the second transmission is identical to the physical resource position first_ft on the frequency domain for the first transmission.

22. The apparatus according to claim 21, wherein when Nf is an odd number, after one odd row position is determined, the relationship between the physical resource positions for two transmissions is that:
one frequency domain SA resource unit remained after even rows are paired is located in the middle of a frequency band, and the physical resource positions for two transmissions satisfy the following relationship:
in a time domain,
as for a clockwise cycle mode, second_nt=mod(Nt+first_nt+first_nf−shift_t, Nt);
as for an anticlockwise cycle mode, second_nt=mod(first_nt+first_nf+shift_t, Nt);
in a frequency domain, second_nf=first_nf+ceil(Nf/2);
or, one frequency domain SA resource unit remained after even rows are paired is located at a tail or tail row of a frequency band, and the physical resource positions for two transmissions satisfy the following relationship:
in a time domain,
as for a clockwise cycle mode, second_nt=mod(Nt+first_nt+first_nf−shift_t, Nt);
as for an anticlockwise cycle mode, second_nt=mod(first_nt+first_nf+shift_t, Nt);
in a frequency domain, second_nf=first_nf+(Nf−1)/2;
where, shift_t is a shift parameter of a time domain unit, and shift_f is a shift parameter of a frequency domain unit; mod represents a modulo operation; and when a resource group mode is adopted, shift_t is less than Nt/2.

23. The apparatus according to claim 15, wherein when the number of frequency domain SA resource units of the resource pool or the resource group is Nf and the number of time domain SA resource units is Nt, the physical resource positions for initial transmission and retransmission of the SA information are fixed and located at different time domain sub-frame and frequency domain positions, and the determination unit is arranged to:
locate the physical resource position for one transmission in the resource pool or the resource group (first_nt, first_nf), and locate the physical resource position for the other transmission in the resource pool or the resource group (second_nt, second_nf), wherein the physical resource positions for two transmissions satisfy the following relationship:
in a time domain,
as for a clockwise cycle mode,
second_nt=mod[Nt+first_nt+floor(first_nf/(2×shift_f))×shift_f+mod(first_nf,shift_f)−shift_t, Nt];
as for an anticlockwise cycle mode,
second_nt=mod[first_nt+floor(first_nf/(2*shift_f))×shift_f+mod(first_nf,shift_f)+shift_t,Nt]; and
in a frequency domain,
second_nt=first_nt+shift_f−floor[(first_nf+shift_f)/Nf]×[1+mod(first_nf,shift_f)];
where, shift_t is a shift parameter of a time domain unit, and shift_f is a shift parameter of a frequency domain unit; and mod represents a modulo operation, and floor is rounding down.

24. The apparatus according to claim 22, wherein when Nf is an odd number, one row of frequency resource is remained after pairing, the physical resource position for one transmission is located at a front part of Nt, and the physical resource position for the other transmission is located at a rear part of Nt; the physical resource positions for two transmissions satisfy the following relationship:
in a time domain, second_nt=first_nt+ceil(Nt/2); and
in a frequency domain, second_nf=first_nf.

25-28. (canceled)

29. A computer-readable storage medium, storing a computer-executable instruction, the computer-executable instruction being used for executing the method according to claim 1.
